(19) United States
(12) Patent Application Publication
(10) Pub. No.: US 2008/0153452 A1
(43) Pub. Date: Jun. 26, 2008

(54) DUAL DISPLAY, DUAL KEYPAD, AND DUAL PROCESSOR ARCHITECTURE FOR POWER CONSERVATION FOR WIRELESS TERMINALS

(75) Inventors: William X. Huang, San Ramon, CA (US); Suyu Bao, Fremont, CA (US); Shanquan Bao, Alameda, CA (US); Liming Gao, Alameda, CA (US); Guang Wan, Fremont, CA (US)

Correspondence Address: UTSTARCOM, INC.;c/o Laura Weiss, Paralegal, 3800 Golf Road, Suite 220, Rolling Meadows, IL, 60008, US

(73) Assignee: UTSTARCOM, INC, Alameda, CA (US)

(21) Appl. No.: 11/615,933

(22) Filed: Dec. 22, 2006

(51) Int. Cl. H04Q 7/20

(52) U.S. Cl. 455/403

(57) ABSTRACT

A mobile information device (MID) incorporates a handset having a primary applications processor, a primary display, a primary input keyboard, a second input keypad, a second display having reduced functionality from the primary display and a card interface. A miniaturized form factor card is received in the card interface which includes a second processor and wireless communications components. The interface provides operable connection from the second processor to the second input keypad and second display. During operations of simple voice call or comparable functions, the primary applications processor, primary display and primary keyboard remain in sleep mode to reduce power consumption for the MID with the call functionality provided by the second processor, second keyboard and second display. During operations requiring higher level functionality, the primary applications processor, primary display and primary keyboard are awakened to provide the necessary capability.

### REFERENCE TO RELATED APPLICATIONS

This application is co-pending with U.S. application Ser. No. 11/308221 filed on Mar. 13, 2006 entitled MINIATURIZED FORM FACTOR WIRELESS COMMUNICATIONS CARD FOR GENERIC MOBILE INFORMATION DEVICES and having the same assignee as the present application.

### BACKGROUND OF THE INVENTION

1. Field of the Invention

This invention relates generally to the field of operating platforms for mobile phones and personal data systems and more particularly to an architecture for power conservation in wireless terminals employing a dual display, dual keypad and dual processor with functional control based on operational conditions.

2. Related Art

Current design time-to-market for mobile phone and personal information devices is extended due to current design philosophy and practice. Turn-around time for a typical complete handset design is about 9 months. Currently terminal vendors need to spend significant amount of resources on basic wireless communication functions and cannot concentrate on truly value-added design works, such as industrial design and software applications. It is also difficult to develop multiple models with significant differences based on a common printed circuit board (PCB) platform. Traditional wireless devices using discrete solution have difficulty supporting multiple band or modes such as GSM, CDMA, 3G. Discrete chipset solutions consume at least three times more PCB space. There are significant financial and technical barriers of entry for new companies without significant resources, or established companies without wireless expertise.

U.S. patent application Ser. No. 11/308221 filed on Mar. 13, 2006 entitled MINIATURIZED FORM FACTOR WIRELESS COMMUNICATIONS CARD FOR GENERIC MOBILE INFORMATION DEVICES, which is incorporated herein by reference in its entirety as though fully set forth, provides a system that can save RF tuning, debugging and certification thereby reducing design lead time significantly. This system provides the ability to integrate hardware, software, utilities and drivers which will allow true plug and play functionality for end users or mobile information device design houses. The desired functional capability is provided through an insertable card to provide a separate CPU or applications processor in the mobile information device for desired functionality and additionally, to provide a complete modern solution that will support multi-mode and multi-band.

For many mobile information devices (MIDs) a complex display, keyboard and processor are required to accomplish the desired functionality of the device. However, for operation as a mobile/cellular phone, the display, keyboard and processor of the MID provide significantly greater capability than required and consume significant power resources that could be reduced with alternative functional components.

It is therefore desirable to provide a method and apparatus for employing alternative display, keyboard and processor capability in an MID. In particular, where an insertable miniaturized form factor card is employed for communications functions wherein a separate processor is employed, it is desirable to provide a secondary keyboard and display with limited functionality to provide power conservation for the MID.

### SUMMARY OF THE INVENTION

The present invention provides a mobile information device (MID) which incorporates a handset having a primary applications processor, a primary display, a primary input keyboard, a second input keypad, a second display having reduced functionality from the primary display and a card interface. A miniaturized form factor card is received in the card interface which includes a second processor and wireless communications components. The interface provides operable connection from the second processor to the second input keypad and second display.

During operations of simple voice call or comparable functions, the primary applications processor, primary display and primary keyboard remain in sleep mode to reduce power consumption for the MID with the call functionality provided by the second processor, second keyboard and second display.

During operations requiring higher level functionality, the primary applications processor, primary display and primary keyboard are awakened to provide the necessary capability.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of an exemplary embodiment of the present invention;

FIGS. 2a and 2b are pictorial representations of an exemplary embodiment of an MID incorporating the present invention;

FIG. 3 is an operational diagram of system function for the MID incorporating the present invention; and,

FIG. 4 is a block diagram representation of an alternative LCD arrangement for combining the primary and reduced capability displays in a single LCD.

### DETAILED DESCRIPTION OF THE INVENTION

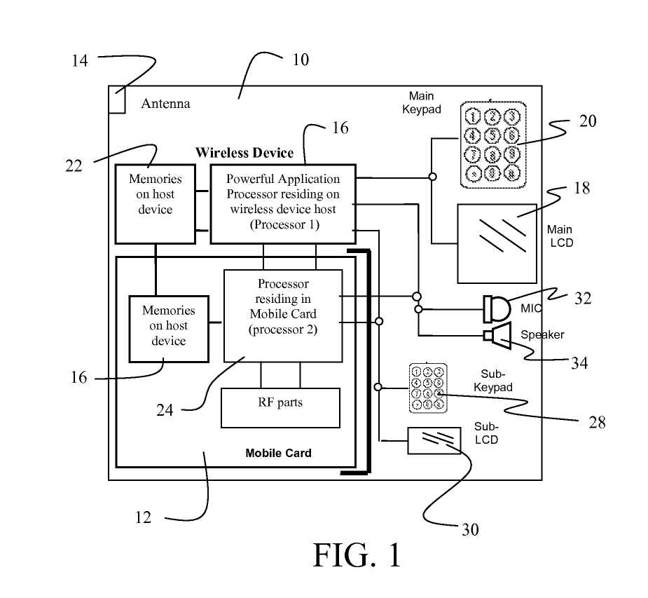

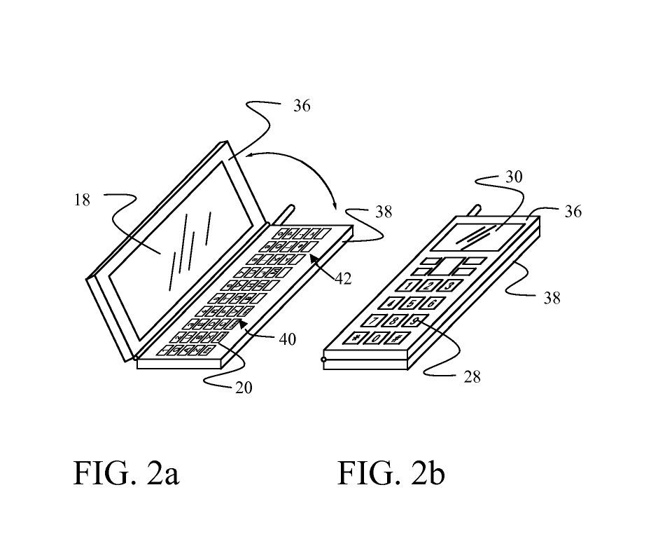

FIG. 1 demonstrates in a block diagram an exemplary embodiment of the present invention. A mobile information device (MID) 10 incorporates a miniaturized form factor card 12 (referred to herein as a “mobile card”) as described in prior referenced U.S. application Ser. No. 11/308221 for wireless communications functionality, received in a connector interface 13. The MID incorporates an antenna 14 for use by the card and incorporates a powerful applications processor 16 and employs a first or primary Liquid Crystal Display (LCD) 18 for the complex operating functions of the device. A first keyboard 20 which includes all key functions required for the MID is also incorporated. Memory 22 is employed by the MID for operational requirements of the applications processor. The first keyboard on FIG. 1 is shown as a simplified representation and will be more fully described with respect to FIGS. 2a and 2b.

For the embodiment shown, the card contains a second processor 24 for wireless communications functions and a second memory 26. The card is connected to a second limited function keyboard 28 and a second LCD 30 having a simplified display. A microphone 32 and speaker 34 are connector to both the card processor and the application processor for use in operations by both systems.

FIGS. 2a and 2b show an arrangement of a MID employing the present invention. The MID primary LCD is incorporated in a folding cover 36 attached to a base 38 as in many handheld computer or personal digital assistant applications. With the cover open as shown in FIG. 2a, primary LCD 18 is exposed for use and the primary keyboard is available for input. For this embodiment, primary keyboard 20 is shown a complete alpha numeric portion 40 with an additional number pad 42. FIG. 2b shows the MID in the closed configuration wherein the mobile phone functionality may be easily employed. Second keypad 28 is provided on the exterior of the cover with second LCD 30. The phone communications functions of the MID can be operated without opening the cover of the device.

The high-performance application processor, main LCD and keyboard of a high-end MID often creates large power consumption; for example, the estimated backlighting and panel power consumption of a Samsung 2.22-inch LCD is about 300 mW (5 LED light source). This is approximately 5 times higher than the power consumption of a 1-inch LCD (one LED light source). Similarly, the estimated power consumption of a high-performance processor under “device on” mode, as will be described subsequently, such as a TI OMAP2420, is approx. 32 mW (for a MPEG-4 video conf. call, approx. 145 mW). This is about 70 times higher than the “sleep” mode for the processor. For a MPEG-4 video conf. call application, the power consumption of application processor and SDRAM (e.g., 512 Mbit SDRAM) could be higher than 200 mW. Users employ their wireless devices (regardless of whether they posses a high-end or low/middle-end wireless device) to do simple voice communications, such as to send/receive a voice call, most of the time rather than using a less complex cellular phone. For these basic communication functions, a large LCD or high-performance processor which are high power consumption components and designed to support multimedia services, are not necessary, a low-end processor and small LCD is good enough.

The present invention reduces the power consumption of a MID by using a low-end processor and small keypad and LCD to handle basic communication functions, meanwhile, the high-performance application processor and the large color LCD of the MID will stay in “sleep” mode to save power, resulting in extending the available usage time of the MID.

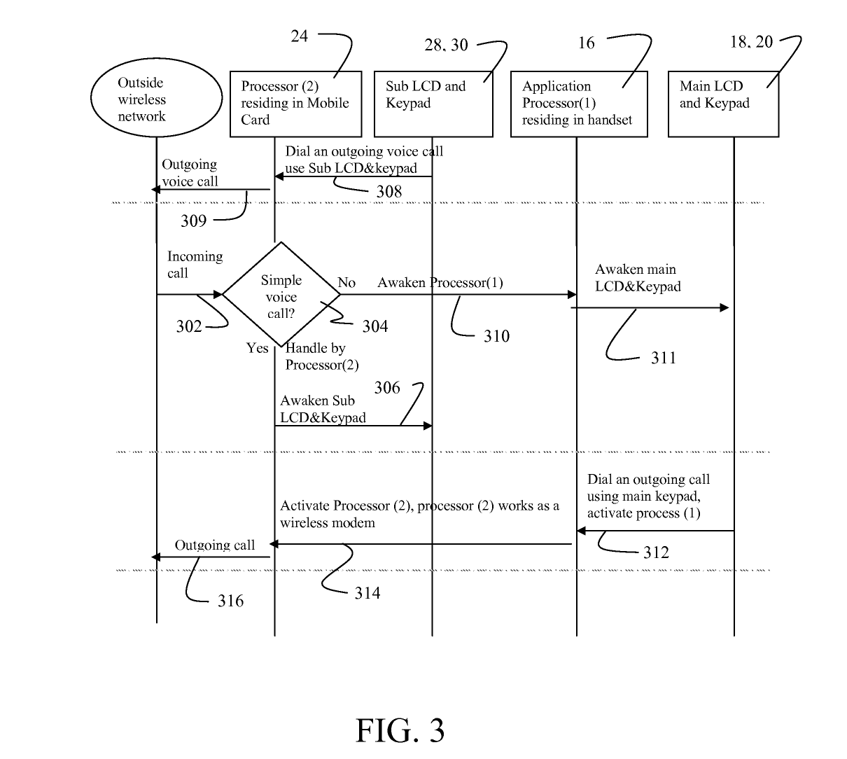

Basic operation of an MID employing the present invention as described above is shown in FIG. 3. The MID employs a handset equipped with dual LCDs, dual keyboard/keypad, and is configured for insertion of a mobile card for communications functions. The application processor residing in the MID handset is a relatively powerful processor (such as an xScale, x86, or comparable system) that controls the primary LCD and keyboard (such as a QWERTY alpha numeric keyboard as previously described), and supports multimedia services (such as MMS, video/audio player, mobile TV, games etc). The memory residing in the handset carries localized or customized software elements tailored for different markets, application and consumers. The second processor residing in the mobile card is a low-end processor and the second LCD and keypad have reduced size and functionality from their primary counterparts.

When a mobile card is plugged into the handset, the processor in the mobile card reads the memory in the handset to upload the software into mobile card memory through an open hardware and software interface. In an exemplary embodiment, the hardware interface is a standard 8 bit NAND flash bus, and software interface is a standard API (such as a TTPCOM AJAR Interface) that provides a standard application interface platform. The mobile card obtains all localized and customized software, such as Power Management software, secondary LCD and keypad driver software, etc, from the memory residing on the host device. The primary application processor residing in the handset connects with the second processor residing in mobile card via open standard ports; a UART in the exemplary embodiment.

There are two User Interfaces (UI) in the handset. One basic UI runs in the mobile card through the second processor and provides basic applications that utilize the second LCD and keypad. This basic UI is resident in the mobile card processor or, in alternative embodiments, is uploaded from the memory residing in the handset. Another UI in the primary processor supports both basic applications and higher level applications, such as video, games etc. Two UI structure provides additional power saving, for example, when user is taking a voice call, only the software application in the second processor is running which consumes much less power than the primary processor running the same software application.

When an incoming call is received 302 as shown in FIG. 3, a determination is made if the call is a simple voice call 304. If so, the second processor residing in the mobile card awakens the second LCD and keypad 306 which are activated along with the audio system provided by the microphone and speakers to fulfill the mobile communication functions. These services do not require the application processor to be involved. Therefore, the high power consumption primary processor will stay in sleep mode to save power, as well as the main LCD/keypad which are controlled by that processor.

Similarly, when the user desires to make an outgoing call, pressing on keys of the second keypad activates the second processor 308 and second LCD for use in placing the outgoing call 309.

When the user presses any key on the main keyboard, or touches the surface of primary LCD (where in certain embodiments, the main LCD is a touch sensitive LCD), the primary applications processor and primary LCD and keyboard will be awakened in “standby” or “device on” mode 310,311. The normal operational functions of the MID will then be available to the user. The user chooses the primary keyboard and display for wireless functions beyond the simple voice call previously described. Upon input to the primary keyboard, the primary applications processor is awakened 312 with the primary LCD and keyboard and the processor in the mobile card is awakened and the mobile card provides capability as a wireless modem 314 for the required mobile communication functions for outgoing call 316. If an incoming call requires greater functionality than available through the secondary processor, the primary applications processor is awakened with the primary LCD and keyboard to accommodate the higher functionality required. The mobile card with its processor and communications components provides communications capability for all incoming/outgoing calls, and handles voice calls, simple data application (e.g., SMS) without awakening the primary processor. Multimedia or other complex applications are handled by the primary applications processor.

Additional power is also saved in the present invention by allowing the primary applications processor and primary LCD to be awakened by the second processor only when higher level applications are invoked. For example, when making a video call, where complex encoding/decoding functions are required, the primary processor is awakened by the second processor in the mobile card.

Conflict resolution routines are employed in the primary and second processor such that when the second processor is handling a call, and user tries to dial another call via primary LCD/Keypad, the call will not be dialed out until the current call is terminated.

For the embodiment shown, if a mobile card has not been plugged into the handset, the dual LCD and dual keypad are controlled by the primary applications processor residing in the handset.

In alternative embodiments of the invention, the second LCD and keyboard are alternatively controlled by either of the processors residing in handset or the mobile card for specific applications.

For the embodiment disclosed herein, a completely separate second LCD and second keypad are shown. In alternative embodiments, the functionality of the second keyboard is provided by using a portion of the primary keyboard, such as number pad 42 of the primary keyboard. The alpha numeric portion of the keyboard is deactivated during reduced power usage. A slide arrangement to allow the number pad to be exposed with out opening the cover of the MID and providing only the second LCD on the exterior of the cover provides an exemplary embodiment of the invention with this capability.

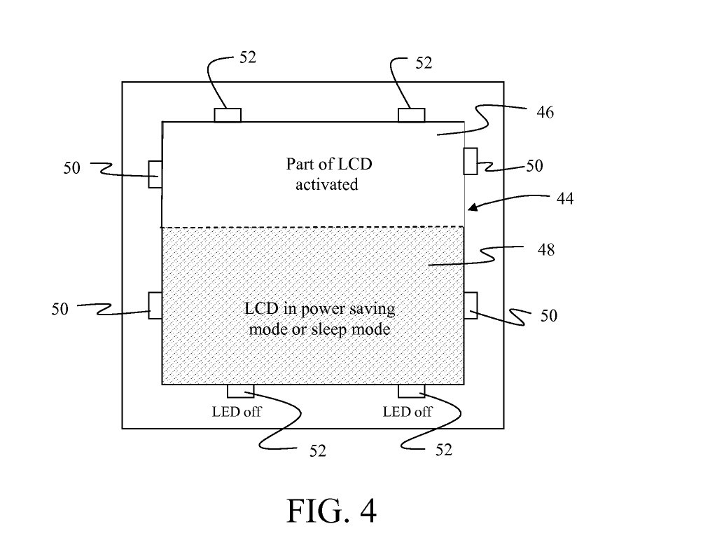

Similarly, as shown in FIG. 4 an LCD 44 having multiple separately controllable sections 46 and 48 provides the functionality of the two LCDs providing the functionality of the two displays within a single LCD screen. For applications requiring the full screen size, both sections are active with the LCD elements 50 and LED elements 52 on. For applications in which the secondary LCD functions are employed, such as in simple voice calls, the second section of the LCD is place in sleep mode and only the first section activated. In this embodiment each section functions as one display or alternatively, the entire LCD (both sections) functions as the primary display while the function of the secondary display with reduced power consumption is provided using only one of the sections. Two sections are disclosed however multiple sections may be employed. Additionally, the present disclosure provides for equal size of the two sections while in alternative embodiments, one section may be only a small portion of the LCD screen.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A mobile information device (MID) comprising:
a handset having
a primary applications processor;
a primary display;
a primary input keyboard;
a second input keypad;
a second display having reduced functionality from the primary display;
a card interface;
a miniaturized form factor card received in the card interface and having a second processor, the interface providing operable connection from the second processor to the second input keypad and second display, the miniaturized form factor card further incorporating wireless communications components.

2. A MID as defined in claim 1 wherein the handset further incorporates a memory interfaced to the primary applications processor and the miniaturized form factor card incorporates a second memory.

3. A MID as defined in claim 1 wherein the primary applications processor, primary input keyboard and primary display are not active during operation of the second input keypad and second display during operation by the second processor.

4. A MID as defined in claim 3 wherein the primary applications processor, primary input keyboard and primary display are in sleep mode during operation of the second input keypad and second display during operation by the second processor.

5. A MID as defined in claim 2 wherein driver applications for the second keypad and second display are downloaded from the memory interfaced to the primary applications processor to the second memory upon insertion of the card into the interface.

6. A method for operation of a mobile information device comprising the steps of:
providing an MID having a a primary applications processor, a primary display, a primary input keyboard, a second input keypad, a second display having reduced functionality from the primary display and an interface in for a miniaturized form factor card;
providing a miniaturized form factor card having a second processor and communications components;
inserting the card into the MID;
when an incoming call is received determining if the call is a simple voice call using the second processor residing in the card;
if the call is a simple voice, activating the second display and keypad for communications functions and handling all call functions through the second processor.

7. A method as defined in claim 6 further comprising the step of awakening the second processor and second display upon activation of the second input keypad for sending a call.

8. A method as defined in claim 6 comprising the steps of:
if the incoming call is determined to not be a simple voice call;
awakening the primary applications processor and primary display for higher level functionality.

9. A method as defined in claim 6 further comprising the step of:
awakening the primary processor and primary display upon pressing of a key on the primary keyboard by a user.

10. A method as defined in claim 6 wherein the provided MID includes a first memory and the card includes a second memory and further comprising step after inserting the card into the MID of uploading drivers for the second keypad and second display into the second memory from the first memory for use by the second processor.
